(19) United States
(12) Patent Application Publication
(10) Pub. No.: US 2013/0001844 A1
(43) Pub. Date: Jan. 3, 2013

(54) ANTI-VIBRATION RUBBER DEVICE

(75) Inventors: Ryota ISHIKAWA, Aichi-ken (JP); Yuichi OGAWA, Aichi-ken (JP); Yorishige SHIMIZU, Aichi-ken (JP)

(73) Assignee: TOKAI RUBBER INDUSTRIES, LTD., Aichi-ken (JP)

(21) Appl. No.: 13/608,218

(22) Filed: Sep. 10, 2012

Related U.S. Application Data
(63) Continuation of application No. PCT/JP2011/075797, filed on Nov. 9, 2011.

(30) Foreign Application Priority Data
Dec. 8, 2010 (JP) 2010-273786

(51) Int. Cl. F16F 15/08; F16F 7/00

(52) U.S. Cl. 267/141

(57) ABSTRACT

An anti-vibration rubber device is capable of advantageously preventing cracks from occurring in a constricted portion because of a long time use in a high-temperature environment. A rubber ring having higher resistance to gas permeability than a main rubber portion is externally inserted in a tension-deformed state to a stress concentration portion of a constricted portion in the main rubber portion that connects a first attachment member and a second attachment member. Due to a restoring force from the tension-deformed state, the rubber ring is tightly attached without being bonded to an outer peripheral surface of the stress concentration portion.

### CLAIM OF PRIORITY

This application is a continuation of PCT/JP2011/075797 filed Nov. 9, 2011, and claims the priority benefit of Japanese Application No. 2010-273786, filed Dec. 8, 2010, the contents of which is expressly incorporated by reference in its entirety.

### TECHNICAL FIELD

The present invention relates to an anti-vibration device, particularly an anti-vibration device suitable for an engine mount for a vehicle, such as an automobile.

### BACKGROUND ART

A type of conventional anti-vibration connector or anti-vibration support provided between two members included in a vibration transmission system is an anti-vibration rubber device having a structure in which a first attachment member and a second attachment member to be attached to the respective two members are connected by a main rubber portion composed of a rubber elastic body having at least one of a block portion and a tubular portion provided between the attachment members. Such an anti-vibration rubber device is generally used as an engine mount, a suspension mount, and a body mount for a vehicle, such as an automobile.

Some anti-vibration rubber device having such a structure described above has a constricted portion having an inward recess in at least one of the block portion and the tubular portion of the main rubber portion. The constricted portion is provided due to the difference in shape of connecting portions of the first and second attachment members and the main rubber portion or due to the attachment structure of the first and second attachment members to the main rubber portion. The constricted portion is also provided to include a stress concentration portion in a central portion in the height direction of the block portion or the tubular portion of the main rubber portion in order to increase the durability of the main rubber portion, the stress concentration portion being a portion where stress is concentrated due to elastic deformation caused by external load. Even in the former case, a stress concentration portion associated with elastic deformation also exists in the constricted portion. The constricted portion herein refers to an inward recess portion extending in the circumferential direction along the entire periphery or less than the entire periphery length of the main rubber portion. The term used below denotes the same meaning.

In use of an anti-vibration rubber device having a main rubber portion provided with such a constricted portion for a long period of time, cracks may occur in the constricted portion. In addition, in a case where such an anti-vibration rubber device is applied to an engine mount for a vehicle, for example, for a long period of time in a location where the temperature reaches 100° C. or higher, such as an engine compartment, cracks are more likely to occur significantly in the constricted portion. It is considered that cracks occur in the constricted portion mainly because of oxidation of rubber that forms the main rubber portion. Such oxidation of rubber is significantly accelerated along with an increase of ambient temperature. Thus, it is considered that cracks occur significantly in use in a high-temperature environment, such as in an engine compartment.

In order to prevent cracks from occurring in the main rubber portion, conventional measures include changing a type of rubber material that forms the main rubber portion to have high heat resistance and improving the shape of the constricted portion in the main rubber portion. Taking such measures may increase material cost due to change of a rubber material type or cause difficulty in achieving predetermined anti-vibration performance due to change of the shape of the main rubber portion.

Under such circumstances, Japanese Patent Laid-Open Publication No. H7-197967 (Patent Literature 1) discloses an anti-vibration device having a structure in which an entire outer peripheral surface of a main rubber portion is covered by a heat-resistant rubber membrane, which is bonded to the entire outer peripheral surface of the main rubber portion. The anti-vibration device having such a structure prevents the outer peripheral surface of the main rubber portion from being exposed to a high-temperature atmosphere in use in a high-temperature environment, thus improving the heat resistance of the main rubber portion.

In such a conventional anti-vibration device, however, the rubber membrane is bonded to the entire outer peripheral surface of the main rubber portion, thus considerably affecting a spring property of the main rubber portion. In order to achieve anti-vibration performance required for the anti-vibration device, the spring property of the main rubber portion should be tuned in consideration of a spring property of the rubber membrane, which is extremely cumbersome. In addition, extra cost and work are required to bond the rubber membrane to the main rubber portion. Furthermore, the rubber membrane, which is simply heat resistant, cannot prevent the outer peripheral surface of the main rubber portion from being in contact with oxygen that permeates the rubber membrane, thus being insufficient in preventing oxidation of the main rubber portion.

### CITATION LIST

### Patent Literature

Japanese Patent Laid-Open Publication No. H-197967

### SUMMARY OF INVENTION

### Technical Problem

In view of the circumstances above, an object of the present invention is to provide an anti-vibration rubber device in which a crack in a constricted portion of a main rubber portion due to long time use under a high-temperature environment is prevented from occurring economically and advantageously without cumbersome work and with a sufficiently limited impact on the spring property of the main rubber portion.

### Solution to Problem

In order to address the circumstances, the inventors of the present invention studied occurrence of cracks generated in a constricted portion of a main rubber portion in use of an anti-vibration rubber device in a high-temperature environment. As a result, it is found that with the use of the anti-vibration rubber device in the high-temperature environment for a long period of time, small cracks are first generated in a front surface of a portion where stress is concentrated in the constricted portion due to elastic deformation of the main rubber portion, and then the cracks penetrate into the main rubber portion due to repeated elastic deformation of the main rubber portion, thus forming cracks to a level that causes a problem in use.

The present invention is achieved by the inventors after much further commitment in research based on the findings above. The present invention essentially provides an anti-vibration rubber device including (a) a main rubber portion including a first attachment member; a second attachment member; and a rubber elastic body provided between and connecting the first attachment member and the second attachment member and having at least one of a block portion and a tubular portion, the first attachment member and the second attachment member being disposed distant from each other, at least one of the block portion and the tubular portion being provided with a constricted portion including a stress concentration portion where stress is concentrated due to elastic deformation by load exerted in a direction in which the first attachment member and the second attachment member are approaching each other; and (b) a rubber ring externally inserted in a tension-deformed state to the stress concentration portion of the constricted portion of the main rubber portion, tightly attached without being bonded to an outer peripheral surface of the stress concentration portion based on a restoring force from the tension-deformed state, and having higher resistance to gas permeability than the main rubber portion.

According to a preferred embodiment of the present invention, the anti-vibration rubber device is used as an engine mount for a vehicle.

According to another preferred embodiment of the present invention, the rubber ring is formed of a butyl rubber or a chloroprene rubber.

### Advantageous Effects of Invention

In the anti-vibration rubber device according to the present invention, the outer peripheral surface of the stress concentration portion of the constricted portion in the main rubber portion is covered and protected by the rubber ring having higher resistance to gas permeability than the main rubber body. Thus, in the use of the anti-vibration rubber device in a high-temperature environment, for instance, the outer peripheral surface of the stress concentration portion of the constricted portion, where cracks start to occur, is advantageously prevented from being exposed to a high-temperature atmosphere and is sufficiently inhibited from being in contact with oxygen permeating the rubber ring. Accordingly, small cracks are efficiently prevented or inhibited from occurring in the front surface of the stress concentration portion of the constricted portion in the use in the high-temperature environment, and thus cracks are effectively prevented from occurring in the constricted portion. Even if cracks occur, the occurrence timing can be sufficiently delayed.

Furthermore, the rubber ring is not tightly attached to the entire outer peripheral surface of the main rubber portion, but only to a portion of the outer peripheral surface, that is, the outer peripheral surface of the stress concentration portion of the constricted portion. Compared to the case where the rubber ring is tightly attached to the entire outer peripheral surface of the main rubber portion, an impact of the rubber ring to the spring property of the main rubber portion is sufficiently reduced.

In addition, to tightly attach the rubber ring to the stress concentration portion of the constricted portion, only a fairly simple operation is required in which the rubber ring is simply pulled to enlarge the diameter and deform elastically, is externally inserted to the constricted portion, and then is released from the tension state. Different from a case where the rubber ring is bonded to the outer peripheral surface of the main rubber portion, the rubber ring is mounted on the constricted portion without a particular material, such as an adhesive agent, facility for bonding, or cumbersome work associated with the use of such a material and facility.

Accordingly, in the anti-vibration rubber device of the present invention, cracks can be economically and advantageously prevented from occurring in the constricted portion of the main rubber portion due to a long time use in a high-temperature environment without cumbersome work and with hardly any impact on the spring property of the main rubber portion. Thus, even in the use in the high-temperature environment, sufficient anti-vibration performance is stably ensured for a longer period of time without extra cost.

### BRIEF DESCRIPTION OF DRAWINGS

FIG. 1 A half view illustrating an anti-vibration rubber device having a structure of the present invention according to an embodiment.

FIG. 2 A plan view illustrating a rubber ring included in the anti-vibration rubber device illustrated in FIG. 1.

FIG. 3 A cross-sectional view along line III-III in FIG. 2.

FIG. 4 A front view illustrating an anti-vibration rubber device having a structure of the present invention according to another embodiment.

FIG. 5 A cross-sectional view of the anti-vibration rubber device illustrated in FIG. 4.

[Reference Signs List]

| | |
|---|---|
| 10, 34: Engine mount | 12, 36: First attachment fitting |
| 14, 38: Second attachment fitting | 16, 40: Main rubber portion |
| 24: Block portion | 26: Tapered tubular portion |
| 28: Constricted portion | 30: Stress concentration portion |
| 32: Rubber ring | |

### DESCRIPTION OF EMBODIMENTS

In order to clarify the present invention further specifically, a configuration of the present invention is described below with reference to the drawings.

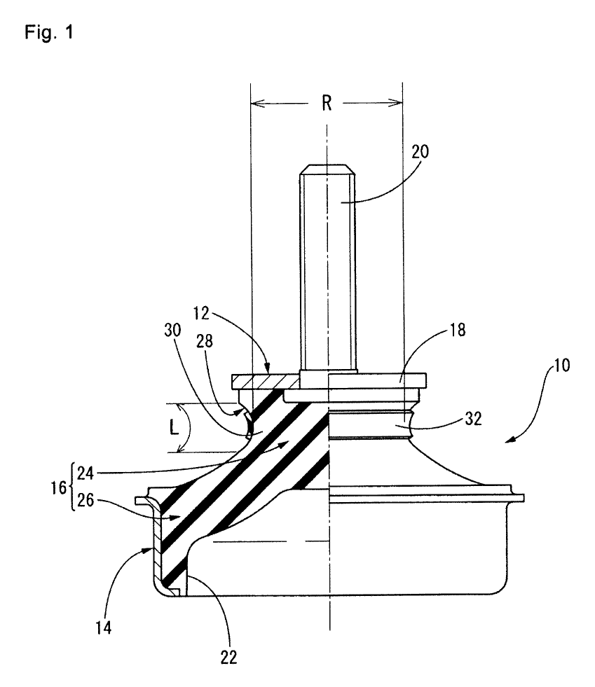

FIG. 1 is a half view illustrating an engine mount for an automobile, which is an anti-vibration rubber device according to an embodiment of the present invention. As shown in FIG. 1, an engine mount 10 of the present embodiment has a structure in which a first attachment fitting 12 as a first attachment member and a second attachment fitting 14 disposed distant therefrom as a second attachment member are integrally connected by a main rubber portion 16 provided between the first attachment fitting 12 and the second attachment fitting 14. Of the engine mount 10, the first attachment fitting 12 is attached to a power unit and the second attachment fitting 14 to a vehicle body (not shown in the drawing). Thus, the power unit is supported on the vehicle body and is prevented from vibrating in a state where the engine mount 10 is disposed in an engine compartment of an automobile. In such a mounted state, a main vibration load is exerted between the first and second attachment fittings 12 and 14 of the engine mount 10 in a vertical direction of the FIG. 1. The vertical direction in the description hereinafter basically refers to the vertical direction of FIG. 1.

More specifically, the first attachment fitting 12 has a thick circular fitting 18 and an attachment bolt 20 integrally standing from a central portion of one surface of the circular fitting 18. The first attachment fitting 12 is attached to the power unit by the attachment bolt 20.

The second attachment fitting 14 is a thin tubular fitting as a whole. An inner diameter thereof is larger than that of the circular fitting 18 of the first attachment fitting 12. The second attachment fitting 14 is attached to the body through a tubular bracket (not shown in the drawing) fixed to the body.

The first attachment fitting 12 is disposed above and concentric to the second attachment fitting 14 with a predetermined distance therebetween in a state where the attachment bolt 20 projects upward. The main rubber portion 16 is provided between the first attachment fitting 12 and the second attachment fitting 14. The main rubber portion 16 is substantially a circular truncated cone-shaped block as a whole. In an end surface thereof on a large diameter side, a large-diameter hollow portion 22 open downward is provided. In other words, the main rubber portion 16 includes a vertically extending columnar block portion 24 having a low height and a thick tapered tubular portion 26 integrally extending downward from an outer peripheral surface of a lower end portion of the block portion 24 and having a diameter gradually increasing downward.

A lower surface of the circular fitting 18 of the first attachment fitting 12 is vulcanized and bonded to an upper end surface of the block portion 24 of the main rubber portion 16, while an inner peripheral surface of the second attachment fitting 14 is vulcanized and bonded to an outer peripheral surface of the large-diameter end portion of the tapered tubular portion 26. Thus, the main rubber portion 16 integrally connects the first attachment fitting 12 and the second attachment fitting 14.

In a state where the engine mount 10 of the present embodiment, which has the first attachment fitting 12 attached to the power unit and the second attachment fitting 14 attached to vehicle body, is disposed in an engine compartment of an automobile, a vibration load is exerted vertically, specifically, a vibration load is exerted in a direction in which the first attachment fitting 12 and the second attachment fitting 14 are moved closer to or more distant from each other. Then, the main rubber portion 16 elastically deforms, and accordingly absorbs the vibration load.

In order to prevent cracks from occurring in the lateral portion of the upper end portion of the main rubber portion 16 due to stress concentrated therein by exertion of the vibration load, specifically, to improve the durability of the main rubber portion 16, the engine mount 10 of the present embodiment is provided with a constricted portion 28 in the upper end portion of the block portion 24. Specifically, the constricted portion 28 refers to a recess continuously extending in the circumferential direction having a recess curved inner surface provided in a portion having the shortest circumferential length (outer peripheral size) of the main rubber portion 16 in a portion above a portion connecting the bock portion 24 and the tapered tubular portion 26. In other words, the constricted portion 28, which is provided in the columnar block portion 24 having an outer diameter substantially the same as that of a small-diameter end portion of the tapered tubular portion 26, includes a minimum length portion having the minimum circumferential length and two lateral portions disposed on two lateral areas of the minimum length portion in the height direction of the block portion 24 and having curved tapered outer peripheral surfaces each of whose circumferential length gradually increases as being departed from the minimum length portion.

In the main rubber portion 16 having such a constricted portion 28, stress generated in association with elastic deformation by excretion of vertical vibration load is concentrated in the minimum length portion having the minimum circumferential length of the constricted portion 28. Specifically, the minimum length portion of the constricted portion 28 serves as a stress concentration portion 30.

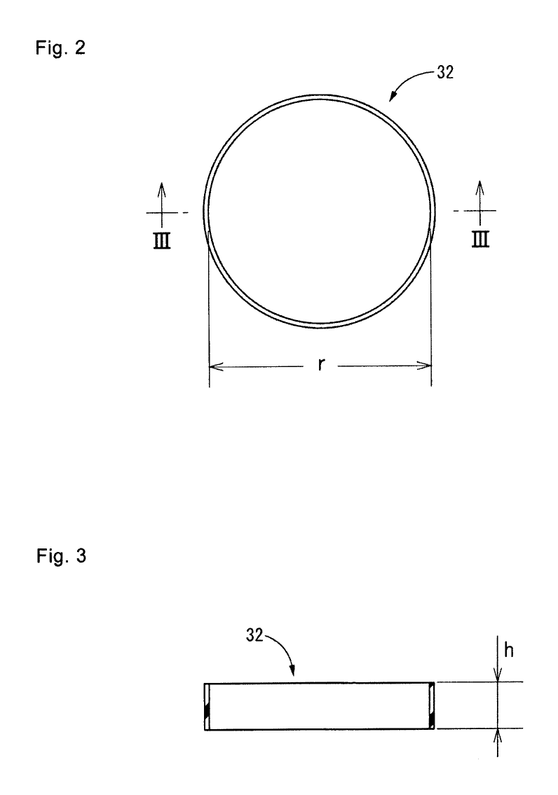

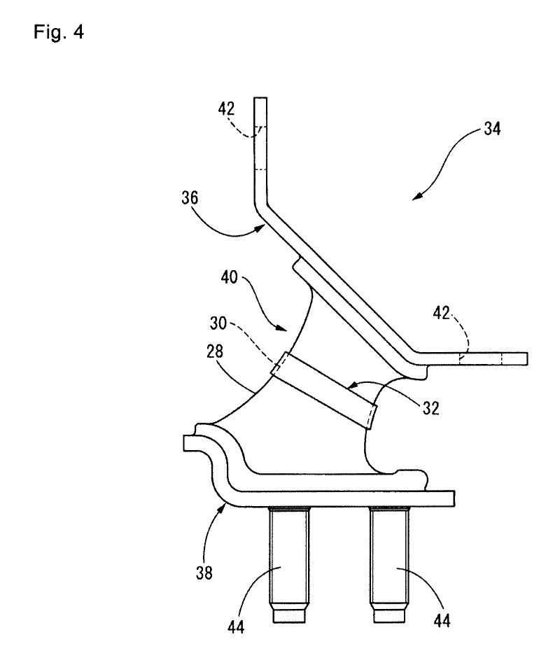

In the present embodiment, a rubber ring 32 is externally inserted to the constricted portion 28 that includes the stress concentration portion 30. With reference to FIGS. 1 to 3, the rubber ring 32 has a constantly thin, low cylindrical or annular shape as a whole. The height (size indicated by h in FIG. 3) of the rubber ring 32 is less than the length (length along the outer peripheral surface of the main rubber portion 16, indicated by L in FIG. 1) of the constricted portion 28 in the height direction (vertical direction in FIG. 1) of the block portion 24. The inner diameter (size indicated by r in FIG. 2) of the rubber ring 32 is less than the outer diameter (minimum outer diameter of the constricted portion 28, indicated by R in FIG. 1) of the stress concentration portion 30 of the constricted portion 28.

Furthermore, the rubber ring 32 is composed of a butyl rubber, which is superior in resistance to gas permeability to a rubber material (e.g., natural rubber) that forms the main rubber portion 16. As is well known, the butyl rubber has not only excellent resistance to gas permeability, but also sufficient resistance to ozone. Thus, the rubber ring 32 has excellent resistance to gas permeability and sufficient resistance to ozone inherent to the properties of butyl rubber.

Such a rubber ring 32, which is externally inserted to the constricted portion 28, covers the entire peripheries of the stress concentration portion 30 and a portion of the constricted portion 28 that includes two lateral portions of the stress concentration portion 30 in the height direction of the block portion 24. Since the inner diameter of the rubber ring 32 is less than the outer diameter of the stress concentration portion 30 of the constricted portion 28 by a predetermined size, the rubber ring 32 externally inserted to the constricted portion 28 is tensile-deformed to increase the diameter. Due to a restoring force from the tensile-deformed state, the rubber ring 32 is tightly attached without being bonded to the outer peripheral surfaces of the stress concentration portion 30 and its two lateral portions.

The rubber ring 32 is thus externally inserted to the constricted portion 28 as a tightly-attached cover to the stress concentration portion 30 and its two lateral portions of the constricted portion 28. Accordingly, in a state where the engine mount 10 is used with the power unit supported on the vehicle body in the engine compartment while being prevented from vibration, the stress concentration portion 30 of the constricted portion 28 is prevented from being directly exposed to a high-temperature atmosphere even if the temperature inside the engine compartment increases to a high level. Since the rubber ring 32 is composed of a butyl rubber having excellent resistance to gas permeability, oxygen is practicably prevented from permeating the rubber ring 32 and coming into contact with the stress concentration portion 30. Thus, the rubber material that forms the stress concentration portion 30 is advantageously prevented or inhibited from being oxidized in the high-temperature atmosphere.

In addition, with sufficient resistance to ozone inherent in the butyl rubber that forms the rubber ring 32, the oxidation prevention effect for the stress concentration portion 30 is effectively prevented from declining due to damage of the rubber ring 32 by ozone attack and thus a reduction in resistance to gas permeability.

Furthermore, the rubber ring 32 is tightly attached along the entire peripheries of the stress concentration portion 30 and its two lateral portions in the constricted portion 28, thus preventing a gap from forming between the rubber ring 32 and the constricted portion 28. Accordingly, it is sufficiently prevented that oxygen enters the gap between the rubber ring 32 and the constricted portion 28 and oxidizes the rubber material that forms the stress concentration portion 30.

Thus, the rubber ring 32 functions as a cover that protects the stress concentration portion 30 of the constricted portion 28 from oxidation and heat impact. In order to sufficiently ensure such a function, it is preferred that the thickness of the rubber ring 32 be 1 mm or greater. In a case where the rubber ring 32 is too thick, however, the spring property of the rubber ring 32 may largely affect the spring property of the main rubber portion 16 (block portion 24) to which the rubber ring 32 is externally inserted in a tightly attached state. To prevent such a possibility, it is preferred that the thickness of the rubber ring 32 be 2 mm or less. Thus, although the thickness of the rubber ring 32 is not limited in particular, it is advantageous that the thickness of the rubber ring 32 is relatively thinner within a range of 1 to 2 mm to keep the spring property of the main rubber portion 16 unchanged and to sufficiently increase oxidation resistance and heat resistance of the stress concentration portion 30 of the constricted portion 28.

As described above, in the engine mount 10 of the present embodiment, the thin rubber ring 32 is externally inserted to the stress concentration portion 30 of the constricted portion 28 in a tightly attached state without being bonded. This prevents oxidation of the stress concentration portion 30 and effectively controls acceleration of such oxidation in the stress concentration portion 30 in a high-temperature atmosphere. Thus, cracks are advantageously prevented from occurring in the constricted portion 28 of the main rubber portion 16 in use in the high-temperature environment in the engine compartment, even without changing the rubber material that forms the main rubber portion 16 to an expensive heat resistant material. Even if cracks occur, the occurrence timing can be effectively delayed. Furthermore, due to the thinness of the rubber ring 32, the spring property of the main rubber portion 16 is advantageously prevented from changing when the rubber ring 32 is externally inserted to the constricted portion 28.

In the engine mount 10, the rubber ring 32 is externally inserted to the stress concentration portion 30 of the constricted portion 28 in a tension state without being bonded, and thus is mounted to the constricted portion 28. Accordingly, only a fairly simple operation is required to mount the rubber ring 32 on the constricted portion 28, in which the rubber ring 32 is simply pulled to enlarge the diameter and deform elastically, is externally inserted to the constricted portion 28, and then is released from the tension state. Different from a case where the rubber ring 32 is bonded to the constricted portion 28, the rubber ring 32 can be mounted on the constricted portion 28 without a particular material, such as an adhesive agent, equipment for bonding, or cumbersome work associated with the use of such a material and equipment.

Thus, the engine mount 10 of the present embodiment stably ensures sufficient anti-vibration performance for a longer period of time in the use in the high-temperature environment in the engine compartment. In addition, ensuring of such sufficient anti-vibration performance is achieved very advantageously, without extra cost or cumbersome work.

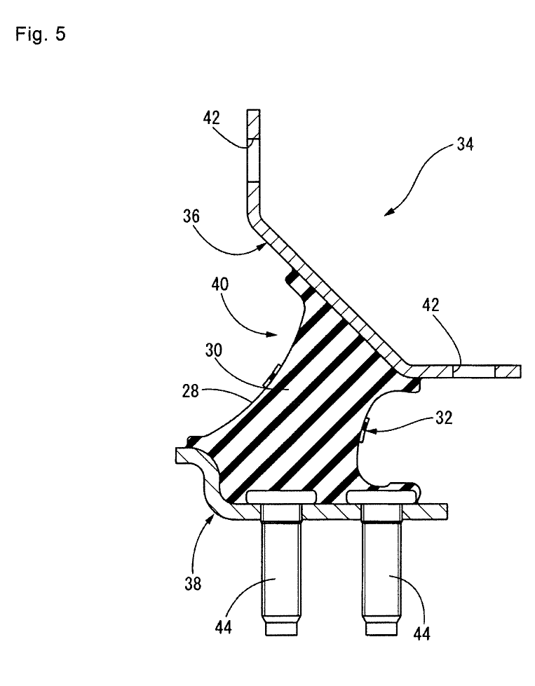

FIGS. 4 and 5 are a front view and a vertical cross-sectional view, respectively, illustrating an engine mount for an automobile as an anti-vibration rubber device according to another embodiment of the present invention. As shown in the drawings, an engine mount 34 of the present embodiment has a structure in which a first attachment fitting 36 as a first attachment member and a second attachment fitting 38 disposed distant therefrom as a second attachment member are integrally connected by a main rubber portion 40 provided between the first attachment fitting 36 and the second attachment fitting 38. Of the engine mount 34, the first attachment fitting 36 is attached to a power unit and the second attachment fitting 38 to a vehicle body. Thus, the power unit is supported on the vehicle body and is prevented from vibration in a state where the engine mount 34 is disposed in an engine compartment of an automobile.

In such a mounted state, a main vibration load is exerted between the first and second attachment fittings 36 and 38 of the engine mount 34 in a vertical direction of the FIG. 4. The vertical direction in the description hereinafter basically refers to the vertical direction of FIG. 4. Members and components similarly structured to those in the first embodiment are denoted with the same reference numerals as in FIG. 1 and detailed descriptions thereof are omitted.

More specifically, the first attachment fitting 36 is a long rectangular metal plate bent at plurality of portions. The first attachment fitting 36 is attached to the power unit by attachment bolts (not shown in the drawing) that pass through bolt insertion holes 42 provided in two end portions in the length direction.

The second attachment fitting 38 is a long rectangular metal flat plate as a whole. The second attachment fitting 38 is attached to the body by two attachment bolts 44 fixedly projecting downward.

The first attachment fitting 36 and the second attachment fitting 38 are disposed opposite to each other in the vertical direction with a predetermined distance therebetween. The main rubber portion 40 is provided between the first and second attachment fittings 36 and 38. The main rubber portion 40 has a block shape extending vertically.

The first attachment fitting 36 is vulcanized and bonded to an upper end surface of the main rubber portion 40, while the second attachment fitting 38 is vulcanized and bonded to a lower end surface thereof. Thus, the main rubber portion 40 integrally connects the first attachment fitting 36 and the second attachment fitting 38.

In a state where the engine mount 34 of the present embodiment, which has the first attachment fitting 36 attached to the power unit and the second attachment fitting 38 attached to vehicle body, is disposed in an engine compartment of an automobile, when a vibration load is exerted vertically, specifically, in a direction in which the first attachment fitting 36 and the second attachment fitting 38 are moved closer to or more distant from each other, the main rubber portion 40 elastically deforms, and accordingly absorbs the vibration load.

In order to mainly improve the durability of the main rubber portion 40 by concentrating stress in a central portion in the height direction of the main rubber portion 40 with the vertical vibration load exerted, the engine mount 34 is provided with a constricted portion 28, which is a substantially drum-shaped central portion in the height direction excluding an upper end portion and a lower end portion of the main rubber portion 40. Thus, a minimum length portion having the minimum circumferential length located in the central portion in the height direction of the constricted portion 28 serves as a stress concentration portion 30 where the stress is concentrated with the vibration load exerted.

A thin cylindrical or annular rubber ring 32 composed of a butyl rubber is externally inserted to the constricted portion 28 of the main rubber portion 40 in a tensile-deformed state so as to cover the entire peripheries of outer peripheral surfaces of the stress concentration portion 30 and two lateral portions of the stress concentration portion 30 in the height direction of the main rubber portion 40, specifically, to cover a portion of the constricted portion 28, including the stress concentration portion 30. Thus, similar to the rubber ring 32 externally inserted to the constricted portion 28 of the main rubber portion 16 of the engine mount 10 according to the first embodiment, the rubber ring 32 is tightly attached without being bonded to the stress concentration portion 30 due to a restoring force from the tension state.

Thus, the engine mount 34 of the present embodiment also extremely effectively achieves functions and effects similar to those achieved by the engine mount 10 of the first embodiment.

The specific configurations of the present invention described in detail above are presented merely as examples and should not be construed to limit the present invention.

For instance, the entire shape of the main rubber portion 16, 40 is by no means limited by the examples. The entire shape may be tubular, for example. In this case, the constricted portion 28 and the stress concentration portion 30 are provided in a portion that has a tubular shape in the main rubber portion. In a case where the main rubber portion has a tubular portion and a block portion, the constricted portion 28 and the stress concentration portion 30 are provided to at least one of the tubular portion and the block portion.

Furthermore, the tubular portion and the block portion of the main rubber portion 16, 40 may have any shape other than a tubular or columnar shape. For instance, the tubular portion may have an oval tubular shape, a tapered tubular shape, or an angular tubular shape. The block portion may have a columnar shape having an oval cross section, a columnar shape having a trapezoidal or circular truncated cone shape, or an angular columnar shape.

Other than those illustrated, the constricted portion 28 may be a grooved portion provided by forming a groove having a V-shaped cross section, a groove having a square-edged U-shaped cross section, or a groove having a U-shaped cross section in the main rubber portion 16, 40 along the entire periphery or less than the entire periphery length of the main rubber portion 16, 40 so as to continuously extend in the circumferential direction. Such a groove portion may serve as the constricted portion 28. The rubber ring 32 is tightly attached without being bonded to the stress concentration portion 30 of the constricted portion 28 in such a variation.

The entire shape of the rubber ring 32 is not particularly limited to an cylindrical shape or an annular shape as illustrated, and may be a tubular shape or a circular shape corresponding to the shape of the constricted portion 28.

Any rubber material having higher resistance to gas permeability than the main rubber portion 16, 40 may be used for the rubber material to form the rubber ring 32. However, in order for the rubber ring 32 to have excellent resistance to gas permeability and ozone resistance, it is preferable to use a chloroprene rubber and the like besides a butyl rubber as illustrated. Using the chloroprene rubber to form the rubber ring 32 provides the rubber ring 32 with high resistance to gas permeability and further excellent ozone resistance.

It is unnecessary that the thickness and the height (width) of the rubber ring 32 be constant in the circumferential direction or in the axis direction (height direction). The thickness and the height may be changed appropriately according to the shape of the constricted portion 28 and the stress concentration portion 30.

In the embodiments above, specific examples are provided in which the present invention is applied to an engine mount of an automobile. The present invention is also advantageously applied to a variety of anti-vibration rubber devices, including an engine mount for a vehicle other than an automobile; and a suspension mount, a body mount, or a component other than a mount for an automobile or other than an automobile.

Although not being individually listed, the present invention can be embodied in manners in which a variety of changes, modifications, and improvements are added based on knowledge of persons skilled in the art. Any such embodiments are included in the scope of the present invention, provided without deviating from the concept of the present invention.

1. An anti-vibration rubber device comprising:
a main rubber portion; and
a rubber ring,
the main rubber portion comprising:
a first attachment member;
a second attachment member; and
a rubber elastic body provided between and connecting the first attachment member and the second attachment member and having at least one of a block portion and a tubular portion,
the first attachment member and the second attachment member being disposed distant from each other,
at least one of the block portion and the tubular portion being provided with a constricted portion including a stress concentration portion where stress is concentrated due to elastic deformation by load exerted in a direction in which the first attachment member and the second attachment member are approaching each other,
the rubber ring externally inserted in a tension-deformed state to the stress concentration portion of the constricted portion of the main rubber portion, tightly attached without being bonded to an outer peripheral surface of the stress concentration portion based on a restoring force from the tension-deformed state, and having higher resistance to gas permeability than the main rubber portion.

2. The anti-vibration rubber device according to claim 1, wherein the anti-vibration rubber device is an engine mount for a vehicle.

3. The anti-vibration rubber device according to claim 1, wherein the rubber ring is formed of a butyl rubber.

4. The anti-vibration rubber device according to claim 1, wherein the rubber ring is formed of a chloroprene rubber.

5. The anti-vibration rubber device according to claim 2, wherein the rubber ring is formed of a butyl rubber.

6. The anti-vibration rubber device according to claim 2, wherein the rubber ring is formed of a chloroprene rubber.
